(19) United States
(12) Patent Application Publication
(10) Pub. No.: US 2025/0349975 A1
(43) Pub. Date: Nov. 13, 2025

(54) SEPARATORS FOR RECHARGEABLE LITHIUM BATTERIES AND RECHARGEABLE LITHIUM BATTERIES INCLUDING THE SAME

(71) Applicant: SAMSUNG SDI CO., LTD., Gyeonggi-do (KR)

(72) Inventors: Jinweon SEO, Gyeonggi-do (KR); Changhong KO, Gyeonggi-do (KR); Sam-Jin PARK, Gyeonggi-do (KR); Soohee KIM, Gyeonggi-do (KR); Jungyoon LEE, Gyeonggi-do (KR); Minjeong LEE, Gyeonggi-do (KR)

(73) Assignee: SAMSUNG SDI CO., LTD., Gyeonggi-do (KR)

(21) Appl. No.: 18/930,198

(22) Filed: Oct. 29, 2024

(30) Foreign Application Priority Data
May 13, 2024 (KR) 10-2024-0062311

(51) Int. Cl. H01M 50/451; H01M 10/0525; H01M 50/42; H01M 50/423; H01M 50/426; H01M 50/434; H01M 50/489

(52) U.S. Cl. CPC H01M 50/451; H01M 50/42; H01M 50/423; H01M 50/426; H01M 50/434; H01M 50/489; H01M 10/0525

(57) ABSTRACT

Disclosed are a separator for a rechargeable lithium battery and a rechargeable lithium battery including the separator. The separator includes a substrate, and a heat resistant adhesive layer on one surface of the substrate. The heat resistant adhesive layer includes inorganic particles, a heat resistant binder, and a swellable adhesive binder. The swellable adhesive binder includes a first structural unit derived from a vinyl aromatic monomer, a second structural unit derived from an alkyl acrylate, and a third structural unit derived from a phosphonate-based monomer, and the swellable adhesive binder is distributed in the surface of the heat-resistant adhesive layer to 40% to 60% of the total thickness of the heat resistant adhesive layer.

### CROSS-REFERENCE TO RELATED APPLICATION

This application claims the benefit of priority to Korean Patent Application No. 10-2024-0062311 filed in the Korean Intellectual Property Office on May 13, 2024, the entire contents of which are incorporated herein by reference.

### BACKGROUND

### 1. Field

Separators for rechargeable lithium batteries, and rechargeable lithium batteries including the separators are disclosed.

### 2. Description of the Related Art

With increasing use of electronic devices that use batteries, such as, e.g., mobile phones, laptop computers, electric vehicles, and the like, the demand for rechargeable batteries with high energy density and high capacity is increasing.

A rechargeable lithium battery typically includes a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and the negative electrode.

Additionally, in order to reduce or prevent short circuits between the positive and negative electrodes of rechargeable lithium batteries, olefin-based substrates are used as separators. The olefin-based substrates have an advantage of desired or improved flexibility, but a disadvantage of rapid heat shrinkage at high temperatures and an insufficient adhesive force.

In order to overcome the insufficient heat resistance of the olefin-based substrates, a method of forming a coating layer including a mixture of inorganic material particles and a binder on the surface of the olefin-based substrates is known.

However, the inorganic material particle and the binder have density differences, so that the binder may be in general distributed mainly in a lower portion of the coating layer rather than an upper portion of the coating layer. Accordingly, when such a coating layer including the mixture of the inorganic material particles and the binder is formed on the olefin-based substrates, an adhesive force on the surface portion of the coating layer may be weakened.

On the other hand, the adhesive force between the separator and the negative electrode may be easily weakened as lithium salt is precipitated on the negative electrode surface by gas generated from the positive electrode, when the rechargeable lithium batteries are charged and discharged and/or stored at high temperatures.

The weakened adhesive force between the separator and the negative electrode due to the reasons described above may, as a result, deteriorate the high temperature charging and discharging and/or storage characteristics of the rechargeable lithium batteries.

### SUMMARY

Some example embodiments include a separator for a rechargeable lithium battery that exhibits desired or improved heat resistance, and that has enhanced adhesive force on the surface portion of the coating layer on at least one surface thereof.

Some example embodiments include a rechargeable lithium battery including the separator.

Some example embodiments include a separator for a rechargeable lithium battery including a substrate, and a heat resistant adhesive layer on one surface of the substrate, wherein the heat resistant adhesive layer includes inorganic particles, a heat resistant binder, and a swellable adhesive binder. The swellable adhesive binder includes a first structural unit derived from a vinyl aromatic monomer, a second structural unit derived from an alkyl acrylate, and a third structural unit derived from a phosphonate-based monomer. When measuring the separator with an FT-IR (Fourier Transform Infrared Spectrometer) in ATR (Attenuated Total Internal Reflectance) mode, the swellable adhesive binder distributed from about 7% to about 12% of the thickness from a surface portion of the heat resistant adhesive layer is detected.

Some example embodiments include a rechargeable lithium battery including the separator.

The separator according to some example embodiments exhibits desired or improved heat resistance, and has enhanced adhesive force on the surface portion of the coating layer on at least one surface, thereby improving the high-temperature charge/discharge and/or storage characteristics of a rechargeable lithium battery.

### BRIEF DESCRIPTION OF THE DRAWINGS

FIGS. 1 to 4 are exploded perspective views of a rechargeable lithium battery, according to some example embodiments.

### DETAILED DESCRIPTION

Hereinafter, example embodiments of the present disclosure will be described in detail. However, these are example embodiments, the present disclosure is not limited thereto and the present disclosure is defined by the scope of claims.

As used herein, when specific definition is not otherwise provided, it will be understood that when an element such as a layer, film, region, or substrate is referred to as being “on” another element, it can be directly on the other element or intervening elements may also be present.

As used herein, when specific definition is not otherwise provided, the singular may also include the plural. In addition, unless otherwise specified, “A or B” may mean “including A, including B, or including A and B.”

As used herein, “combination thereof” may mean a mixture, a stack, a composite, a copolymer, an alloy, a blend, and a reaction product of constituents.

As used herein, when a definition is not otherwise provided, a particle size may be an average particle size. This average particle size means an average particle size (D50), which is a diameter of particles with a cumulative volume of 50 volume % in the particle size distribution. The average particle size (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle size (D50) value may be easily obtained through a calculation. A laser diffraction method may also be used. When measuring by laser diffraction, and for example, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

As used herein, when a specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when a specific definition is not otherwise provided, “substituted” refers to replacement of at least one hydrogen atom by a substituent including at least one of a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when a specific definition is not otherwise provided, “hetero” refers to inclusion of at least one heteroatom of N, O, S, and P in chemical formulas.

As used herein, when a specific definition is not otherwise provided, “(meth)acrylate” refers to both “acrylate” and “methacrylate,” and “(meth)acrylic acid” refers to “acrylic acid” and “methacrylic acid.

As used herein, when a specific definition is not otherwise provided, “combination” refers mixing or copolymerization.

In chemical formulas of the present specification, unless a specific definition is otherwise provided, hydrogen is bonded at the position when a chemical bond is not drawn where supposed to be given.

As used herein, a weight average molecular weight (Mw) may be a value measured using gel permeation chromatography (GPC).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Separator

Some example embodiments include a separator for a rechargeable lithium battery, the separator including a substrate, and a heat resistant adhesive layer on one surface of the substrate, wherein the heat resistant adhesive layer includes inorganic particles, a heat resistant binder, and a swellable adhesive binder, the swellable adhesive binder includes a first structural unit derived from a vinyl aromatic monomer, a second structural unit derived from an alkyl acrylate, and a third structural unit derived from a phosphonate-based monomer. When measuring the separator with an FT-IR (Fourier Transform Infrared Spectrometer) in ATR (Attenuated Total Internal Reflectance) mode, the swellable adhesive binder distributed from about 7% to about 12% of the thickness from a surface portion of the heat resistant adhesive layer is detected.

Hereinafter, the main components that constitutes the separator of some example embodiments will be described.

The separator of some example embodiments includes a heat resistant adhesive layer including inorganic particles, a heat resistant binder, and a swellable adhesive binder on at least one surface of the substrate.

The inorganic particles and the heat resistant binder are components that contribute to improving the heat resistance of the heat resistant adhesive layer.

Additionally, the swellable adhesive binder is a component that contributes to improving the adhesive force of the heat resistant adhesive layer.

Accordingly, the heat resistant adhesive layer including the inorganic particles, the heat resistant binder, and the swellable adhesive binder can harmoniously exhibit both heat resistance and adhesive force by one layer.

In examples, the heat resistant adhesive layer can satisfy both of Equations 1 and 2 below, and there is a higher probability that the swellable adhesive binder may be distributed on the surface portion of the heat resistant adhesive layer compared to when any of Equations 1 and 2 is not satisfied:

$$1 / 20 < ( A + B ) / C < 1 / 5 \qquad Equation 1$$

$$1 / 30 < A / B < 1 / 2 \qquad Equation 2$$

In Equations 1 and 2, A is a weight of the heat resistant binder, B is a weight of the swellable adhesive binder, C is a weight of the inorganic particles.

For example, Equation 1 may satisfy Equation 1-1, and Equation 2 may satisfy Equation 2-1 below:

$$1 / 12 \leq ( A + B ) / C \leq 1 / 7 \qquad Equation 1 - 1$$

$$1 / 19 \leq A / B \leq 1 / 13 \qquad Equation 2 - 1$$

In Equations 1-1 and 2-1, the definitions of A, B and C are as described above.

The high probability that the swellable adhesive binder is distributed on the surface of the heat-resistant adhesive layer may be indirectly determined by measuring FT-IR (Fourier Transform Infrared Spectrometer) in ATR (Attenuated Total internal Reflectance) mode on the separator.

When FT-IR is measured in attenuated total reflection mode for a specific sample, total reflection of incident light may occur at the interface between the sample and the total reflection crystal (ATR crystal). When total reflection occurs, an evanescent field is generated at the interface of the total reflection crystal, and at this time, the evanescent field penetrates a certain distance into the sample in contact with the crystal, making it possible to record a spectral spectrum for the depth of penetration.

Herein, the depth of penetration depends on factors such as an angle of incidence of infrared rays, observation wavelength, and refractive index of the sample and total reflection crystal, and is defined according to Equation 3:

$${D}_{p} = \frac{1}{2 π v {n}_{c} √ ( {sin}^{2} {θ}_{e - {n}_{sc}^{2}} )} \qquad Equation 3$$

Dₚ=depth of penetration
n=wavelength (cm⁻¹)
n_{c}=refractive index (crystal)
n_{sc}=refractive index (nₛ/n_{c})
θₑ=effective angle of incidence

The conditions used in the separator analysis are as follows.
Diamond (f45, n to 2.4) crystal
infrared ray angle of incidence 45
refractive index of heat resistant adhesive layer n to 1.5
1730 cm⁻¹ observation wavelength, 1080 cm⁻¹ observation wavelength

Based on the above theoretical explanation, the separator may be measured with respect to FT-IR in attenuated total reflection mode to obtain a relative distribution of different particles and a penetration depth of specific particles.

For example, when the separator is measured with respect to FT-IR in attenuated total reflection mode, a ratio of (a first absorbance peak at about 1730 cm⁻¹)/(a second absorbance peak at about 1080 cm⁻¹) may be in a range of about 0.05 to about 0.1, for example, about 0.06 to about 0.099.

Herein, the first absorbance peak may be caused by a C═O functional group of the swellable adhesive binder, and the second absorbance peak may be caused by an Al—O—H bond of the inorganic particles (e.g., boehmite).

The relative ratio of the first absorbance peak to the second absorbance peak may allow for relative comparison of a depth penetration of the swellable adhesive binder to the inorganic particles.

Comprehensively considering these measurement results with Equation 3, a distribution of the swellable adhesive binder may be detected to about 7% to about 12% of the thickness, for example, about 7.3% to about 11.9% of the thickness from the surface portion of the heat resistant adhesive layer.

Herein, the ‘detection’ is defined as detection during FT-IR measurement in attenuated total reflection mode for the separator, wherein the swellable adhesive binder is concentratedly distributed to the detection range, but even beyond the detection range, may still be distributed, but at a lower level.

Within the detection range, the higher distribution, the more concentratedly the swellable adhesive binder may be distributed in the surface portion of the heat resistant adhesive layer, thereby improving an adhesive force on the heat resistant adhesive layer surface. However, when beyond the detection range, the distribution of the inorganic particles may be relatively lowered on the surface portion of the heat resistant adhesive layer, thereby reducing heat resistance of the separator.

Hereinafter, the separator of some example embodiments will be described in more detail.

### Properties of Separator

A separator according to some example embodiments includes the heat resistant adhesive layer, and may thus secure a dry shrinkage rate at about 150° C. within a range of about 5% and a wet adhesive force greater than or equal to about 0.1 gf/mm after a process under low temperature and low pressure conditions.

A separator having the above physical properties can improve the high-temperature charging/discharging and/or storage characteristics of a rechargeable lithium battery.

### Swellable Adhesive Binder

Generally known binders can only exhibit wet adhesive strength under high-temperature and high-pressure conditions.

However, prismatic rechargeable lithium batteries are manufactured by inserting a jelly roll in which a stack of positive electrode/separator/negative electrode is wound into a prismatic can, and then injecting an electrolyte solution. However, high-temperature and high-pressure conditions cannot be applied during and/or after the manufacturing process. Accordingly, when commonly known binders are applied to prismatic rechargeable lithium batteries, wet adhesive strength is not secured.

On the other hand, the swellable adhesive binder includes a first structural unit derived from a vinyl aromatic monomer, a second structural unit derived from an alkyl acrylate, and a third structural unit derived from a phosphonate-based monomer, so that wet adhesive strength may be achieved even under low-temperature and low-pressure conditions.

Accordingly, the separator according to some example embodiments can secure wet adhesive strength even under low-temperature and low-pressure conditions during the manufacturing process (for example, formation process) of a prismatic rechargeable lithium battery.

The first structural unit derived from the vinyl aromatic monomer may be represented by Chemical Formula 1.

The second structural unit derived from the alkyl acrylate may be represented by Chemical Formula 2.

The third structural unit derived from the phosphonate-based monomer may be represented by Chemical Formula 3.

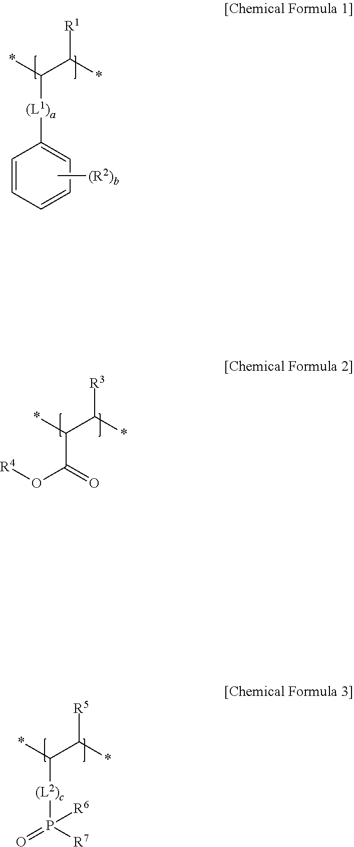

The descriptions of Chemical Formulas 1 to 3 are as follows:
R¹, R³, and R⁵ may each independently be or include a hydrogen or a C1 to C6 alkyl group. As an example, R¹ may be or include hydrogen, R³ may be or include a methyl group, and R⁵ may be or include at least one of a hydrogen or a methyl group.

R² may be or include at least one of fluorine, a substituted or unsubstituted C1 to C6 alkyl group, a substituted or unsubstituted C6 to C20 aryl group, or a substituted or unsubstituted C1 to C6 alkenyl group.

R⁴ may be or include a substituted or unsubstituted C1 to C20 alkyl group.

As an example, R⁴ may be or include a 2-ethylhexyl group.

L¹ may be or include at least one of a substituted or unsubstituted C1 to C6 alkylene group, a substituted or unsubstituted C3 to C10 cycloalkylene group, a substituted or unsubstituted C6 to C20 arylene group, or a combination thereof.

L² may be or include at least one of a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof. For example, L² may be or include an ether group (—O—).

R⁶ may be or include at least one of a hydroxy group (—OH), a substituted or unsubstituted C1 to C6 alkoxy group, or a substituted or unsubstituted C6 to C20 aryloxy group. For example, R⁶ may be or include a hydroxy group (—OH).

R⁷ may be or include at least one of a hydroxy group (—OH), or a substituted or unsubstituted C1 to C6 alkoxy group. For example, R⁷ may be or include a hydroxy group (—OH).

The “a” and “c” in the above chemical formulae may each independently be integers in the range of 0 to 2, and “b” may be an integer in the range of 0 to 5. As an example, “a” may be equal to 0, “b” may be equal to 0, and “c” may be equal to 1.

Based on 100 wt % of the swellable adhesive binder, the first structural unit may be included in an amount that is greater than or equal to about 40 wt % and less than or equal to about 80 wt %, or about 50 wt % to about 70 wt %; the second structural unit may be included in an amount of about 5 wt % to about 40 wt %, or about 10 wt % to about 30 wt %; and the third structural unit may be included in an amount of about 0.1 wt % to about 20 wt %, or about 5 wt % to about 20 wt %.

The swellable adhesive binder is in the form of a particle and can maintain a particle form without dissolving in an aqueous solvent.

For example, the swellable adhesive binder may be or include a particle of a core-shell structure, in which case it is advantageous to secure an appropriate average particle size and a degree of swelling. Components of the core are not particularly limited and may be or include, for example, at least one of an acrylic polymer, a diene polymer, or a copolymer thereof. The shell may include at least a first structural unit derived from a vinyl aromatic monomer; a second structural unit derived from an alkyl acrylate; and a third structural unit derived from a phosphonate-based monomer.

For example, a D50 particle size of the swellable adhesive binder may be about 0.1 μm to about 1 μm, about 0.2 μm to about 0.9 μm, about 0.2 μm to about 0.8 μm, or about 0.2 μm to about 0.7 μm. Within any of the above ranges, the heat resistant adhesive layer can achieve desired or improved adhesive strength even at a thin thickness without deteriorating the heat resistance of the separator.

A glass transition temperature of the swellable adhesive binder may be about 60° C. to about 120° C., about 65° C. to about 90° C., or about 60° C. to about 75° C. Within any of the above ranges, the swellable adhesive binder is advantageous for exhibiting wet adhesive strength even under low-temperature and low-pressure conditions, and the heat resistant adhesive layer can realize desired or improved adhesive strength, even at a thin or low thickness without deteriorating the heat resistance of the separator.

After being left in an electrolyte solution at 60° C. for 72 hours, the swellable adhesive binder may expand about 2 to about 1,000 times, about 3 to about 1,000 times, or about 6 to about 1,000 times an initial volume thereof.

Within any of the above ranges, the swellable adhesive binder is advantageous for exhibiting wet adhesive strength even under low-temperature and low-pressure conditions, and the heat resistant adhesive layer can realize desired or improved adhesive strength, even with a small thickness without reducing the heat resistance and air permeability of the separator.

A composition of the electrolyte solution follows the example.

A weight average molecular weight of the swellable adhesive binder may be about 100,000 g/mol to about 800,000 g/mol, or about 300,000 g/mol to about 500,000 g/mol as measured by GPC method.

In the heat resistant adhesive layer, a loading amount of the swellable adhesive binder may be about 0.05 g/m² to about 1.0 g/m².

### Heat Resistant Binder

The heat resistant binder may be or include at least one of a first heat resistant binder and a second heat resistant binder, or a combination thereof.

The first heat resistant binder may include a fourth structural unit derived from (meth)acrylic acid or (meth)acrylate, a fifth cyano group-containing structural unit, and a sixth sulfonate group-containing structural unit.

The fourth structural unit derived from (meth)acrylic acid or (meth)acrylate may be represented by any one of Chemical Formula 11, Chemical Formula 12, Chemical Formula 13, and a combination thereof.

The fifth cyano group-containing structural unit may be represented by Chemical Formula 14.

The sixth sulfonate group-containing structural unit may be represented by any one of Chemical Formula 15, Chemical Formula 16, Chemical Formula 17, and a combination thereof.

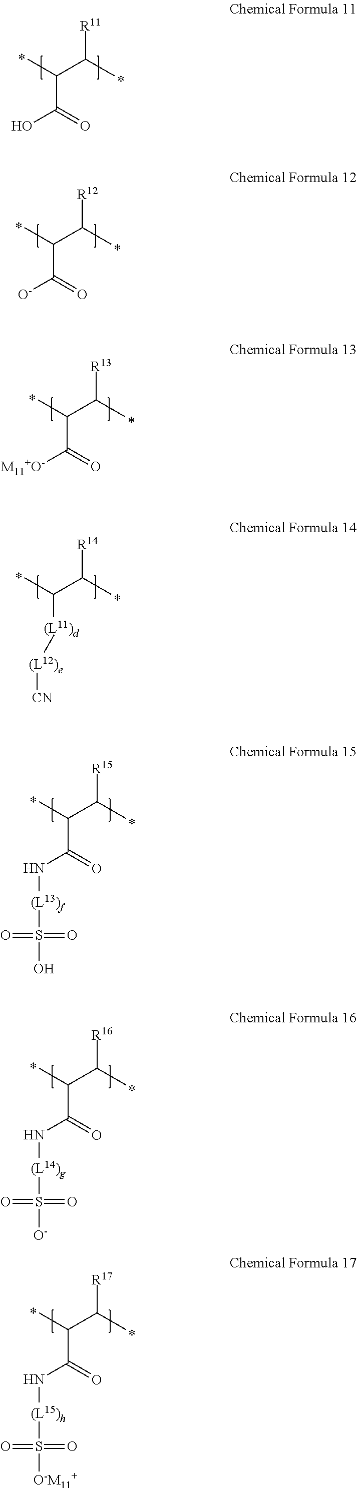

The descriptions of Chemical Formulas 11 to 17 are as follows:
R¹¹ to R¹⁷ may each independently be or include hydrogen or a C1 to C6 alkyl group. As an example, R¹¹ to R¹⁷ may all be hydrogen.

L¹¹ and L¹² may each independently be or include at least one of a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹¹ and L¹² may all be a single bond.

L¹³ to L¹⁵ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹³ to L¹⁵ may all be *—C(CH₃)₂—CH₂—*.

M₁₁ may be or include an alkali metal. The alkali metal may be or include at least one of lithium, sodium, potassium, rubidium, or cesium, and for example, may be or include lithium or sodium.

d, e, f, g, and h in the above formulae may each independently be integers in a range of 0 to 2. For example, d, e, f, g, and h may all be equal to 1.

The fourth structural unit derived from (meth)acrylic acid or (meth)acrylate may include, respectively or together, the structural unit represented by Chemical Formula 11 and the structural unit represented by Chemical Formula 13. In this case, the structural unit derived from (meth)acrylic acid or (meth)acrylate may include the structural unit represented by Chemical Formula 11 and the structural unit represented by Chemical Formula 13 in a molar ratio of about 1:10 to about 2:1, about 1:5 to about 1:1, or about 1:1 to about 1:3.

The sixth sulfonate group-containing structural unit may include, respectively or together, the structural unit represented by Chemical Formula 15 and the structural unit represented by Chemical Formula 17. In this case, the sixth sulfonate group-containing structural unit may include the structural unit represented by Chemical Formula 15 and a structural unit represented by Chemical Formula 17 in a molar ratio of about 1:10 to about 2:1, about 1:5 to about 1:1, or about 1:1 to about 1:3.

Based on 100 mol % of the heat resistant binder, the fourth structural unit may be included in an amount greater than or equal to about 10 mol % to less than or equal to about 70 mol %, greater than or equal to about 30 mol % to less than or equal to about 60 mol %, or greater than or equal to about 40 mol % to less than or equal to about 50 mol %; the fifth structural unit may be included in an amount of greater than or equal to about 30 mol % to less than or equal to about 85 mol %, greater than or equal to about 40 mol % to less than or equal to about 70 mol %, or greater than or equal to about 45 mol % to less than or equal to about 55 mol %; and the sixth structural unit may be included in an amount of greater than or equal to about 0.1 mol % to less than or equal to about 20 mol %, greater than or equal to about 0.5 mol % to less than or equal to about 15 mol %, or greater than or equal to about 1 mol % to less than or equal to about 10 mol %.

Examples of the heat resistant binder are as follows:

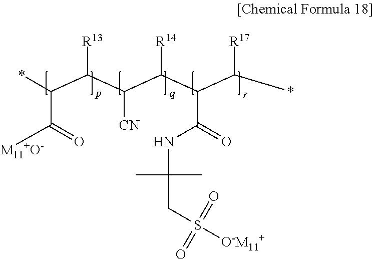

In Chemical Formula 18, M₁₁ may be or include an alkali metal. The alkali metal may be or include at least one of lithium, sodium, potassium, rubidium, or cesium, for example lithium or sodium.

The p, q, and r in Chemical Formula 18 represent a molar ratio of each unit, and may be 0.1≤p≤0.7, 0.3≤m≤0.85, and 0.001≤n≤0.2. Desirably, they may be 0.3≤p≤0.6, 0.4≤q≤0.7, and 0.005≤r≤0.15. More desirably, they may be 0.4≤p≤0.5, 0.45≤q≤0.55, and 0.01≤r≤0.1.

The first heat resistant binder represented by the Chemical Formula 18 may be or include poly(acrylic acid-co-acrylonitrile-co-lithium 2-acrylamido-2-methylpropanesulfonate salt).

The first heat resistant binder may be prepared by various known methods such as, e.g., emulsion polymerization, suspension polymerization, massive polymerization, solution polymerization, or bulk polymerization.

The first adhesive binder may have a weight average molecular weight (Mw) of about 200,000 g/mol to about 700,000 g/mol as measured by a GPC method.

The second heat resistant binder may include a seventh structural unit including at least one of a structural unit derived from (meth)acrylic acid or (meth)acrylate and a structural unit derived from (meth)acrylamide, and an eighth structural unit derived from (meth)acrylamidosulfonic acid or a salt thereof.

The structural unit derived from the (meth)acrylic acid or (meth)acrylate may be represented by any one of Chemical Formula 101, Chemical Formula 102, Chemical Formula 103, and a combination thereof.

The structural unit derived from the (meth)acrylamide may be represented by Chemical Formula 104.

The eighth structural unit derived from the (meth)acrylamidosulfonic acid or the salt thereof may be represented by any one of Chemical Formula 105, Chemical Formula 106, Chemical Formula 107, and a combination thereof.

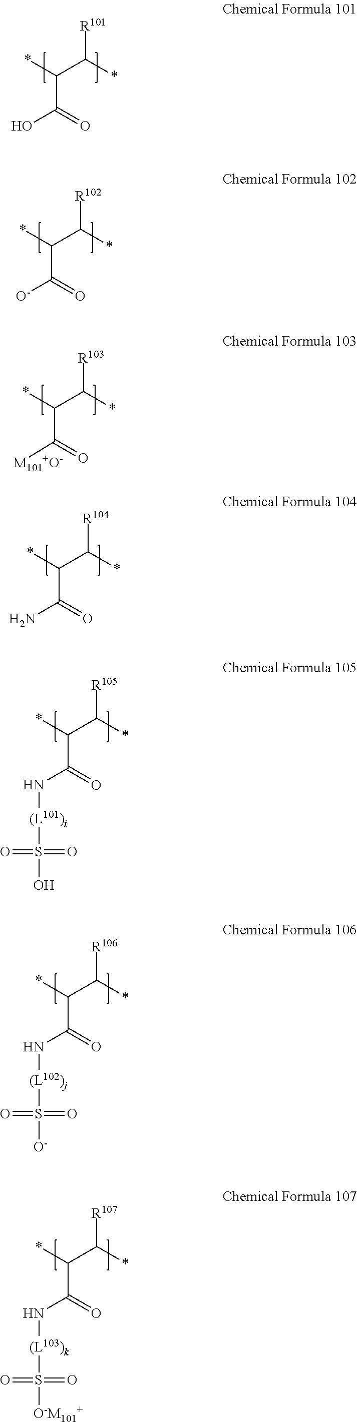

The descriptions of Chemical Formulas 101 to 107 are as follows:
R¹⁰¹ to R¹⁰⁷ may each independently be or include hydrogen or a C1 to C6 alkyl group. As an example, R¹⁰¹ to R¹⁰⁷ may all be hydrogen.

L¹⁰¹ to L¹⁰³ may each independently be or include at least one of a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹⁰¹ to L¹⁰³ may all be *—C(CH₃)₂—CH₂—*.

M₁₀₁ may be or include an alkali metal. The alkali metal may be or include at least one of lithium, sodium, potassium, rubidium, or cesium, for example lithium or sodium.

i, j, and k in the above formulae may each independently be integers in a range of 0 to 2. As an example, i, j, and k may all be equal to 1.

The structural unit derived from (meth)acrylic acid or (meth)acrylate may include, respectively, or together, the structural unit represented by Chemical Formula 101 and the structural unit represented by Chemical Formula 103. In the latter case, the structural unit derived from the (meth)acrylic acid or (meth)acrylate may include the structural unit represented by Chemical Formula 101 and the structural unit represented by Chemical Formula 103 in a molar ratio of about 1:10 to about 2:1, about 1:5 to about 1:1, or about 1:1 to about 1:3.

The eighth structural unit derived from the (meth)acrylamidosulfonic acid or the salt thereof may include respectively, or together, the structural unit represented by Chemical Formula 105 and the structural unit represented by Chemical Formula 107. In the latter case, the structural unit derived from (meth)acrylamidosulfonic acid or the salt thereof may include the structural unit represented by Chemical Formula 5 and the structural unit represented by Chemical Formula 7 in a molar ratio of about 1:10 to about 2:1, about 1:5 to about 1:1, or about 1:1 to about 1:3.

Based on 100 mol % of the second heat resistant binder, the seventh structural unit may be included in an amount greater than or equal to about 50 mol % to less than about 100 mol %, or greater than or equal to about 55 mol % to less than about 100 mol %; and the eighth structural unit may be included in an amount of greater than about 0 mol % and less than or equal to about 50 mol % or greater than about 0 mol % and less than or equal to about 45 mol %.

Examples of the second heat resistant binder are as follows:

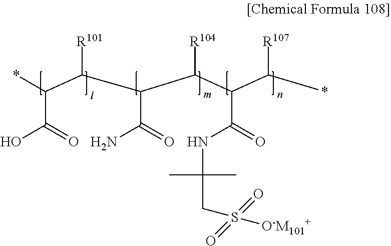

In Chemical Formula 108, M₁₀₁ may be or include an alkali metal. The alkali metal may be or include at least one of lithium, sodium, potassium, rubidium, or cesium, for example lithium or sodium.

l, m, and n in Chemical Formula 108 indicate a molar ratio of each unit, 0.9≤(l+m)<1, and 0<n≤0.1, and l+m+n=1. Desirably, 0≤l≤50.4, 0.55≤m≤0.95, and 0≤n≤0.1. More desirably, 0<l≤0.05, 0.9≤m≤0.95, and 0<n≤0.05.

The second heat resistant binder represented by Chemical Formula 108 may be or include poly(acrylic acid-co-acrylamide-co-lithium 2-acrylamido-2-methylpropanesulfonate salt).

The second heat resistant binder may be prepared by various known methods such as, e.g., emulsion polymerization, suspension polymerization, bulk polymerization, solution polymerization, or bulk polymerization.

The second heat resistant binder may have a weight average molecular weight of about 350,000 g/mol to about 970,000 g/mol as measured by GPC method.

### Inorganic Particles

The inorganic particles can reduce the possibility of a short circuit between the positive electrode and the negative electrode, and reduce or prevent the separator from rapidly shrinking or deforming due to a rise in temperature. That is, the inorganic particles can improve the heat resistance and safety of the battery by including inorganic particles.

The inorganic particles may be or include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

For example, the inorganic particles may be or include boehmite, which makes it easy to control the D50 particle size and shape.

The D50 particle size of the inorganic particles may be about 0.1 μm to about 10 μm, about 0.1 μm to about 5 μm, or about 0.1 μm to about 1 μm.

When the inorganic particles are plate-shaped or fibrous, an aspect ratio of the inorganic particles may be about 1:5 to about 1:100, for example, about 1:10 to about 1:100, about 1:5 to about 1:50, or about 1:10 to about 1:50. For example, a ratio of the length of the major axis to the minor axis on the flat surface of the plate-shaped inorganic particle may be about 1 to 3 or about 1 to 2. The aspect ratio and the ratio of the length of the major axis to the minor axis may be measured using an optical microscope. When the aspect ratio and the length range of the minor axis to the major axis discussed above are satisfied, a heat shrinkage rate of the separator can be lowered, relatively improved porosity can be secured, and the physical stability of the lithium battery can be improved.

### Thickness of Heat Resistant Adhesive Layer

The thickness of the heat resistant adhesive layer is not particularly limited, but may be 5% to 45%, or 10% to 30% of the thickness of the substrate, based on the thickness of the heat resistant adhesive layer formed on one surface of the porous substrate.

For example, a thickness of the heat resistant adhesive layer may be about 0.1 μm to about 4 μm, or about 0.1 μm to about 3 μm.

### Heat Resistant Layer

The separator of some example embodiments may include a heat resistant adhesive layer on one surface of the substrate, and may further include a heat resistant layer on the other surface of the substrate. The heat resistant layer can exhibit desired or improved heat resistance.

The heat resistant layer may include inorganic particles that are the same as or different from the heat resistant adhesive layer, and a heat resistant binder that is the same as or different from the heat resistant adhesive layer. Descriptions of the inorganic particles and the heat resistant binder are omitted below as they are described above.

The thickness of the heat resistant layer may be about 0.1 μm to about 4 μm. In this range, the separator of some example embodiments can exhibit remarkable or improved heat resistance.

### Substrate

The substrate may be or include a porous substrate.

The porous substrate may be or include at least one of a polymer film formed of or including a polymer, or a copolymer or mixture of two or more of polyolefin such as at least one of polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

For example, the porous substrate may be or include a polyolefin-based substrate containing polyolefin, and the polyolefin-based substrate may have an improved or desired shutdown function, which can contribute to improving the safety of the battery. The polyolefin-based substrate may be or include at least one of, for example, a polyethylene single film, a polypropylene single film, a polyethylene/polypropylene double film, a polypropylene/polyethylene/polypropylene triple film, and a polyethylene/polypropylene/polyethylene triple film. Additionally, the polyolefin-based resin may include a non-olefin resin in addition to an olefin resin, or may include a copolymer of olefin and non-olefin monomer.

The porous substrate may have a thickness of about 1 μm to about 40 μm, for example about 1 μm to about 30 μm, about 1 μm to about 20 μm, about 5 μm to about 20 μm, about 5 μm to about 15 μm, or about 5 μm to about 10 μm.

### Manufacturing Method

The separator for a rechargeable lithium battery according to some example embodiments may be manufactured by various known methods. For example, a separator for a rechargeable lithium battery may be formed by coating a composition for forming each layer on one or both surfaces of a porous substrate and then drying it.

The coating may be or include, for example, at least one of spin coating, dip coating, bar coating, die coating, slit coating, roll coating, inkjet printing, and the like, but is not limited thereto.

The drying may be, for example, performed through natural drying, drying with warm air, hot air, or low humid air, vacuum-drying, or radiation of a far-infrared ray, an electron beam, and the like, but the present disclosure is not limited thereto. The drying process may be performed at a temperature of, for example, about 25° C. to about 120° C.

The separator for a rechargeable lithium battery may be manufactured by lamination, coextrusion, and the like, in addition to the aforementioned method.

### Rechargeable Lithium Battery

Some example embodiments include a rechargeable lithium battery including a positive electrode; a negative electrode; and the aforementioned separator between the positive electrode and the negative electrode.

The heat resistant adhesive layer may be attached to the negative electrode. Accordingly, even when gas is generated from the positive electrode when storing and/or charging and discharging the rechargeable lithium battery at high temperature, the adhesive force between the separator and the negative electrode can be maintained.

Hereinafter, descriptions that overlap with those described above will be omitted, and a rechargeable lithium battery according to some example embodiments will be described in more detail.

### Positive Electrode Active Material

The positive electrode active material may be or include a compound (lithiated intercalation compound) capable of intercalating and deintercalating lithium. For example, one or more types of composite oxides of lithium and a metal including at least one of cobalt, manganese, nickel, and combinations thereof may be used.

The composite oxide may be or include a lithium transition metal composite oxide, and examples thereof may include at least one of lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

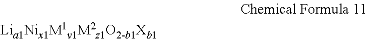

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more of Al, B, Ba, Ca, Ce, Co, Cr, Cu, Fe, Mg, Mn, Mo, Nb, Si, Sn, Sr, Ti, V, W, and Zr, and X is one or more element of F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

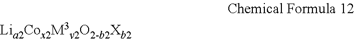

In Chemical Formula 12, 0.9≤a2≤1.8, 0.7≤x2≤1, 0≤y2≤0.3, 0.9≤x2+y2≤1.1, and 0≤b2≤0.1, M³ is or includes one or more of Al, B, Ba, Ca, Ce, Cr, Cu, Fe, Mg, Mn, Mo, Ni, Se, Si, Sn, Sr, Ti, V, W, Y, Zn and Zr, and X is or includes one or more of F, P, and S.

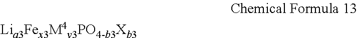

In Chemical Formula 13, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn and Zr, and X is or includes one or more of F, P, and S.

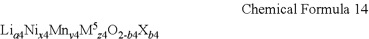

In Chemical Formula 14, 0.9≤a2≤1.8, 0.8≤x4≤1, 0≤y4≤0.2, 0≤4≤0.2, 0.9≤x4+y4+z4≤1.1, and 0≤b4≤0.1 M⁵ is or includes one or more of Al, B, Ba, Ca, Ce, Cr, Fe, Mg, Mo, Nb, Si, Sn, Sr, Ti, V, W, and Zr, and X is or includes one or more of F, P, and S.

As an example, the positive electrode active material may be or include a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials can achieve high capacity and can be applied to a high-capacity, high-density rechargeable lithium battery.

### Positive Electrode

The positive electrode for a rechargeable lithium battery may include a current collector and a positive electrode active material layer on the current collector. The positive electrode active material layer may include a positive electrode active material, and may further include a binder and/or a conductive material.

For example, the positive electrode may further include an additive to constitute a sacrificial positive electrode.

A content of the positive electrode active material may be about 90 wt % to about 99.5 wt %, and a content of the binder and the conductive material may be about 0.5 wt % to about 5 wt %, respectively based on 100 wt % of the positive electrode active material layer.

The binder is configured to attach the positive electrode active material particles to each other and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may be configured to impart conductivity (e.g., electrical conductivity) to the electrode. Any material that does not cause chemical change (e.g., does not cause an undesirable chemical change in the rechargeable lithium battery) and that conducts electrons, may be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material including at least one of copper, nickel, aluminum, silver, etc., in a form of a metal powder or a metal fiber; a conductive polymer such as a polyphenylene derivative; or a mixture thereof.

The current collector may include Al, but is not limited thereto.

### Negative Electrode Active Material

The negative electrode active material may be or include at least one of a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon or a combination thereof. The crystalline carbon may be or include graphite such as non-shaped, plate-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy may include lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include at least one of a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be or include a composite of silicon and amorphous carbon. According to some example embodiments, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery includes a current collector and a negative electrode active material layer on the current collector. The negative electrode active material layer includes a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may be configured to attach the negative electrode active material particles to each other, and also to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is the negative electrode binder, the aqueous binder may further include a cellulose-based compound capable of imparting viscosity. The cellulose-based compound includes one or more of carboxylmethyl cellulose, hydroxypropylmethyl cellulose, methyl cellulose, or alkali metal salts thereof. The alkali metal may be or include at least one of Na, K, or Li.

The dry binder may be or include a polymer material capable of being fiberized, and may be or include, for example, at least one of polytetrafluoroethylene, polyvinylidene fluoride, polyvinylidene fluoride-hexafluoropropylene copolymer, polyethylene oxide, or a combination thereof.

The conductive material is included to provide electrode conductivity, and any electrically conductive material may constitute a conductive material unless the electrically conductive material causes a chemical change. Examples of the conductive material may be or include a carbon-based material such as at least one of natural graphite, artificial graphite, carbon black, acetylene black, ketjen black, a carbon fiber, a carbon nanofiber, a carbon nanotube, and the like; a metal-based material such as copper, nickel, aluminum silver, and the like in a form of a metal powder or a metal fiber; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof, but is not limited thereto.

### Electrolyte Solution

The electrolyte solution for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, alcohol-based solvent, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone. The alcohol-based solvent may include at least one of ethyl alcohol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and the like.

The non-aqueous organic solvent may be used alone or in combination of two or more solvents.

For example, when using a carbonate-based solvent, cyclic carbonate and chain carbonate can be mixed and used, and cyclic carbonate and chain carbonate may be mixed at a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of a lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

### Rechargeable Lithium Battery

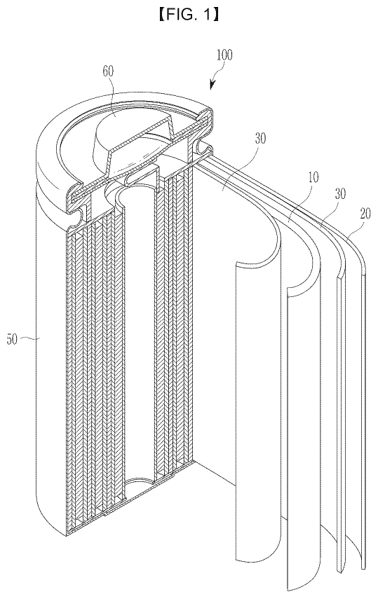

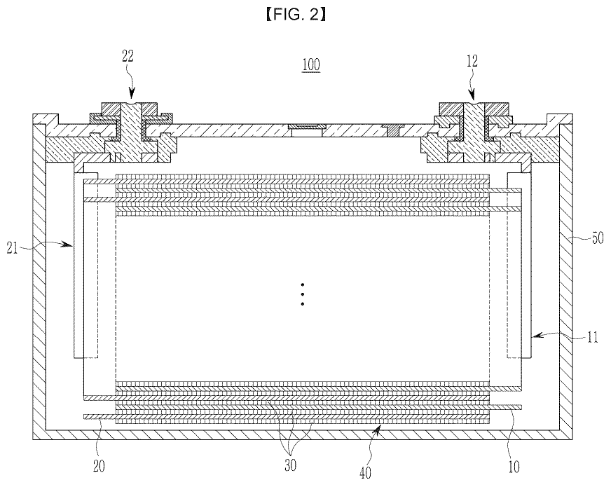

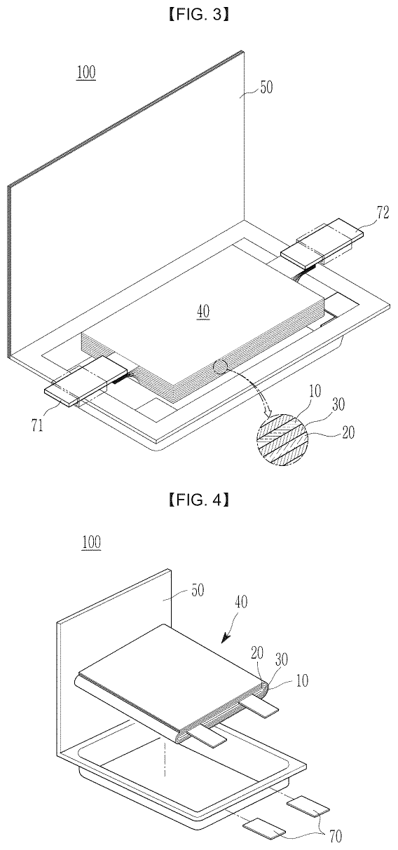

The rechargeable lithium battery may be classified into cylindrical, prismatic, pouch, or coin-type batteries, and the like depending on their shape. FIGS. 1-4 are schematic views illustrating a rechargeable lithium battery according to some example embodiments. FIG. 1 shows a cylindrical battery, FIG. 2 shows a prismatic battery, and FIGS. 3 and 4 show pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). The rechargeable lithium battery 100, in addition to the separator 30 between the positive electrode 10 and the negative electrode 20, and the case 50, may include a sealing member 60 sealing the case 50 as shown in FIG. 1. In addition, in FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the tabs 70/71/72 forming an electrical path for inducing the current formed in the electrode assembly 40 to the outside of the battery 100.

The rechargeable lithium battery according to some example embodiments may be applicable to, e.g., automobiles, mobile phones, and/or various types of electrical devices, but the present disclosure is not limited thereto.

Hereinafter, examples of the present disclosure and comparative examples are described. These examples, however, are not in any sense to be interpreted as limiting the scope of the disclosure.

### PREPARATION EXAMPLES AND COMPARATIVE PREPARATION EXAMPLES

### Preparation Example 1: Preparation of Composition for Forming Heat Resistant Adhesive Layer

### (1) Preparation of Swellable Adhesive Binder

A swellable adhesive binder with a core-shell structure having a D50 particle size of 0.5 μm, a glass transition temperature of 65° C., a swelling degree of 8 times was prepared.

In the swellable adhesive binder, a core includes a copolymer of alkylacrylate and divinylbenzene, and a shell includes a copolymer of 70 wt % of styrene, 20 wt % of 2-ethylhexylmethacrylate, and 10 wt % of acrylphsophonate.

In addition, “the swelling degree” of the swellable adhesive binder refers to a swelling degree after being allowed to stand in an electrolyte solution at 60° C. for 72 hours relative to an initial volume, wherein the electrolyte solution is a mixed solution of ethyl carbonate (EC)/ethylmethyl carbonate (EMC)/diethyl carbonate (DEC) (in a volume ratio of 3/5/2) including LiPF₆ at a concentration of 1.3 M. Hereinafter, the definition of “the swelling degree” of the swellable adhesive binder is the same as above.

### (2) Preparation of Heat Resistant Binder

The first heat resistant binder, the second heat resistant binder, or a combination thereof may be used as a heat resistant binder, but herein, the second heat resistant binder was used.

A method of preparing the second heat resistant binder is as follows.

In a 10 L four-necked flask equipped with a stirrer, a thermometer, and a cooling tube, after adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and 5 N lithium hydroxide aqueous solution (1.05 equivalents based on a total amount of 2-acrylamido-2-methylpropanesulfonic acid), the operation of reducing an internal pressure to 10 mmHg with diaphragm pump and returning the internal pressure to normal pressure with nitrogen, was repeated three times.

While controlling the temperature of reaction solution so as to be stable between 65° C. to 70° C. stable, the reaction was conducted for 12 hours. After cooling to room temperature, the pH of the reaction solution was adjusted to 7 to 8 using a 25% aqueous ammonia solution.

The poly(acrylic acid-co-acrylamide-co-lithium 2-acrylamido-2-methylpropanesulfonate salt) was prepared in this manner. Herein, the molar ratio of the structural unit derived from acrylic acid, the structural unit derived from acrylamide, and the structural unit derived from 2-acrylamido-2-methylpropanesulfonic acid was 10:85:5. About 10 mL of the reaction solution (reaction product) was taken and measured with respect to the non-volatile component, which was 9.5% (theoretical value: 10%).

### (3) Preparation of Composition for Forming Heat Resistant Adhesive Layer

Boehmite with a D50 particle size of 0.3 μm was used as the inorganic particles. In water as a solvent, a weight ratio of the swellable adhesive binder and heat resistant binder to the inorganic particles (swellable adhesive binder and heat resistant binder: inorganic particles) was set to 1:9, and a weight ratio of heat resistant binder to the swellable adhesive binder (heat resistant binder: swellable adhesive binder) was set to 1:19 to prepare a composition for forming a heat resistant adhesive layer.

### Preparation Example 2

A composition for forming a heat resistant adhesive layer was prepared in the same manner as Preparation Example 1, with a difference that the weight ratio of the heat resistant binder to the swellable adhesive binder was changed to 1:16.

### Preparation Example 3

A composition for forming a heat resistant adhesive layer was prepared in the same manner as Preparation Example 1, with a difference that the weight ratio of the heat resistant binder to the swellable adhesive binder was changed to 1:13.

### Preparation Example 4

A composition for forming a heat resistant adhesive layer was prepared in the same manner as Preparation Example 1, with a difference that the weight ratio of the swellable adhesive binder and heat resistant binder to the inorganic particles was changed to 1:10.

### Preparation Example 5

A composition for forming a heat resistant adhesive layer was prepared in the same manner as Preparation Example 1, with a difference that the weight ratio of the swellable adhesive binder and heat resistant binder to the inorganic particles was changed to 1:12.

### Preparation Example 6

A composition for forming a heat resistant adhesive layer was prepared in the same manner as Preparation Example 1, with a difference that the weight ratio of the swellable adhesive binder and heat resistant binder to the inorganic particles was changed to 1:8.

### Preparation Example 7

A composition for forming a heat resistant adhesive layer was prepared in the same manner as Preparation Example 1, with a difference that the weight ratio of the swellable adhesive binder and heat resistant binder to the inorganic particles was changed to 1:7.

### Preparation Example 8

A second heat resistant binder was prepared in the same manner as in Preparation Example 1, and boehmite with a D50 particle size of 0.3 μm was used as the inorganic particles. A composition for forming a heat resistant layer was prepared by mixing heat resistant binder and inorganic particles in a weight ratio of 1:9 in water as a solvent.

### Comparative Preparation Example 1

A composition for forming a heat resistant adhesive layer was prepared in the same manner as in Preparation Example 1 with a difference that the weight ratio of the heat resistant binder to the swellable adhesive binder was changed to 1:2.

### Comparative Preparation Example 2

A composition for forming a heat resistant adhesive layer was prepared in the same manner as in Preparation Example 1 with a difference that the weight ratio of the heat resistant binder to the swellable adhesive binder was changed to 1:30.

### Comparative Preparation Example 3

A composition for forming a heat resistant adhesive layer was prepared in the same manner as in Preparation Example 1 with a difference that the weight ratio of the swellable adhesive binder and the heat resistant binder to the inorganic particles was changed to 1:20.

### Comparative Preparation Example 4

A composition for forming a heat resistant adhesive layer was prepared in the same manner as in Preparation Example 1 with a difference that the weight ratio of the swellable adhesive binder and the heat resistant binder to the inorganic particles was changed to 1:5.

### EXAMPLES AND COMPARATIVE EXAMPLES

### Example 1

### (1) Preparation of Separator

In the following method, a heat resistant adhesive layer was formed on one surface of a substrate, and on the other surface of the substrate, a heat resistant layer was formed.

Negative electrode side: An 8.0 μm-thick polyethylene film (PE, SK Innovation Co., Ltd.) is used as a substrate, and the composition for a heat resistant adhesive layer according to Preparation Example 1 was coated at 20 m/min is coated in a direct metering method and dried at 60° C. under an (average) absolute aqueous vapor amount of 14 g/m³ to form a heat resistant adhesive layer (a thickness: 2 μm) thereon

As a result of forming the heat resistant adhesive layer, a loading amount of a swellable adhesive binder on the surface facing the negative electrode is provided in Table 1.

Positive electrode side: A heat resistant layer (thickness: 2 μm) is formed on the other surface of the substrate using the same method as above, with a difference that the composition for forming a heat resistant layer of Preparation Example 8 is used.

### (2) Manufacturing of Rechargeable Lithium Battery Cells

LiNi_{0.91}Co_{0.05}Al_{0.04}O₂ as a positive electrode active material, polyvinylidene fluoride as a binder, and carbon as a conductive material were mixed in a weight ratio of 92:4:4, and then, dispersed in N-methyl-2-pyrrolidone to prepare positive electrode slurry. The slurry was coated on a 20 μm-thick Al foil, dried, and compressed to manufacture a positive electrode.

Artificial graphite as a negative electrode active material, a styrene-butadiene rubber as a binder and carboxylmethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

The separator is sandwiched between the positive electrode and the negative electrode to manufacture a stack, the stack was wound to make a jelly-roll, the jelly-roll was placed in a prismatic case, and electrolyte solution was injected to manufacture a prismatic battery cell.

The electrolyte solution was a mixed solution of ethyl carbonate (EC)/ethyl methyl carbonate (EMC)/diethyl carbonate (DEC) (volume ratio of 3/5/2) including 1.3 M LiPF₆.

### Example 2

A separator and a rechargeable lithium battery cell were manufactured in the same manner as in Example 1 with a difference that the method of manufacturing the negative electrode surface was changed.

Negative electrode side: A heat resistant adhesive layer (thickness: 2 μm) was formed in the same manner as in Example 1 with a difference that the composition for forming a heat resistant adhesive layer according to Preparation Example 2 was formed on one surface of the substrate.

As a result of forming the heat resistant adhesive layer, a loading amount of a swellable adhesive binder on the surface facing the negative electrode was shown as in Table 1.

### Example 3

A separator and a rechargeable lithium battery cell were manufactured in the same manner as in Example 1 with a difference that the method of manufacturing the negative electrode surface alone was changed as follows.

Negative electrode side: A heat resistant adhesive layer (a thickness: 2 μm) was formed on one surface of a substrate in the same manner as in Example 1 with a difference that the composition for forming a heat resistant adhesive layer of Preparation Example 3 was used.

As a result of forming the heat resistant adhesive layer as above, a loading amount of a swellable adhesive binder on the surface facing the negative electrode was as shown in Table 1.

### Example 4

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Preparation Example 4 was used.

As a result of forming the heat resistant adhesive layer as above, a loading amount of a swellable adhesive binder on the surface facing the negative electrode was as shown in Table 1.

### Example 5

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Preparation Example 5 was used.

As a result of forming the heat resistant adhesive layer as above, a loading amount of a swellable adhesive binder on the surface facing the negative electrode was as shown in Table 1.

### Example 6

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Preparation Example 6 was used.

As a result of forming the heat resistant adhesive layer as above, a loading amount of a swellable adhesive binder on the surface facing the negative electrode was as shown in Table 1.

### Example 7

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Preparation Example 7 was used.

As a result of forming the heat resistant adhesive layer as above, a loading amount of a swellable adhesive binder on the surface facing the negative electrode was as shown in Table 1.

### Comparative Example 1

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Comparative Preparation Example 1 was used.

As a result of forming the heat resistant adhesive layer as above, a loading amount of a swellable adhesive binder on the surface facing the negative electrode was as shown in Table 1.

### Comparative Example 2

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Comparative Preparation Example 2 was used.

As a result of forming the heat resistant adhesive layer as above, a loading amount of a swellable adhesive binder on the surface facing the negative electrode was as shown in Table 1.

### Comparative Example 3

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Comparative Preparation Example 3 was used.

As a result of forming the heat resistant adhesive layer as above, a loading amount of a swellable adhesive binder on the surface facing the negative electrode was as shown in Table 1.

### Comparative Example 4

A separator and a rechargeable lithium battery cell were manufactured in the same manner as in Example 1 with a difference that the method of manufacturing the negative electrode surface alone was changed as follows.

Negative electrode side: A heat resistant adhesive layer (thickness: 2 μm) was formed in the same manner as in Example 1 with a difference that the composition for forming a heat resistant adhesive layer according to Comparative Preparation Example 4 was used.

As a result of forming the heat resistant adhesive layer as above, a loading amount of a swellable adhesive binder on the surface facing the negative electrode was as shown in Table 1.

The separators of the examples and the comparative examples were respectively summarized in Table 1 below.

TABLE 1

| | Heat resistant adhesive layer | | | | | |
|---|---|---|---|---|---|---|
| | | Swellable adhesive binder | | | | |
| | Heat | | Loading amount | | | |
| | resistant | | at negative | | | |
| | binder | Composition | electrode side | Equation | Equation | Thickness |
| | Type | of shell | (g/m²) | 1 | 2 | (μm) |
| Example 1 | Second heat | SM-EHMA- | 0.16 | 1/9 | 1/19 | 2 |
| | resistant | phosphorus- | | | | |
| | binder | based acryl | | | | |
| Example 2 | Second heat | SM-EHMA- | 0.12 | 1/9 | 1/16 | 2 |
| | resistant | phosphorus- | | | | |
| | binder | based acryl | | | | |
| Example 3 | Second heat | SM-EHMA- | 0.11 | 1/9 | 1/13 | 2 |
| | resistant | phosphorus- | | | | |
| | binder | based acryl | | | | |
| Example 4 | Second heat | SM-EHMA- | 0.14 | 1/10 | 1/19 | 2 |
| | resistant | phosphorus- | | | | |
| | binder | based acryl | | | | |
| Example 5 | Second heat | SM-EHMA- | 0.10 | 1/12 | 1/19 | 2 |
| | resistant | phosphorus- | | | | |
| | binder | based acryl | | | | |
| Example 6 | Second heat | SM-EHMA- | 0.17 | ⅛ | 1/19 | 2 |
| | resistant | phosphorus- | | | | |
| | binder | based acryl | | | | |
| Example 7 | Second heat | SM-EHMA- | 0.17 | 1/7 | 1/19 | 2 |
| | resistant | phosphorus- | | | | |
| | binder | based acryl | | | | |
| Comparative | Second heat | SM-EHMA- | 0.08 | 1/9 | ½ | 2 |
| Example 1 | resistant | phosphorus- | | | | |
| | binder | based acryl | | | | |
| Comparative | Second heat | SM-EHMA- | 0.20 | 1/9 | 1/30 | 2 |
| Example 2 | resistant | phosphorus- | | | | |
| | binder | based acryl | | | | |
| Comparative | Second heat | SM-EHMA- | 0.06 | 1/20 | 1/19 | 2 |
| Example 3 | resistant | phosphorus- | | | | |
| | binder | based acryl | | | | |
| Comparative | Second heat | SM-EHMA- | 0.22 | ⅕ | 1/19 | 2 |
| Example 4 | resistant | phosphorus- | | | | |
| | binder | based acryl | | | | |

### EVALUATION EXAMPLES

The evaluation results for each separator of Examples and Comparative Examples are shown in Table 2 below.

### Evaluation Example 1: Dry Shrinkage Rate of Separator

After cutting each of the separators of Examples and Comparative Examples into a size of 10 cm×10 cm to prepare samples, the samples are allowed to stand at 150° C. for 1 hour in a convection oven to calculate a length variation ratio of a machine direction (MD) and a transverse direction (TD), and the results are shown in Table 2.

### Evaluation Example 2: ATR-FTIR

The separators according to the examples and the comparative examples were respectively mounted on an FT-IR (Fourier Transform Infrared Spectrometer) equipment having a diamond (f45, n-2.4) crystal to measure FT-IR in ATR (Attenuated Total internal Reflectance) mode and thus detect a wavelength at which incident light (45°) was totally reflected.

As a result, a first absorbance peak (a peak caused by a C═O functional group of the swellable adhesive binder) at 1730 cm⁻¹ and a second absorbance peak (a peak caused by an Al—O—H bond of the boehmite) at 1080 cm⁻¹ were detected.

After 5 times measuring each of the peaks to obtain arithmetic means, a ratio of (the first absorbance peak at 1730 cm⁻¹)/(the second absorbance peak at 1080 cm⁻¹) was calculated, and the results are shown in Table 2.

In addition, the ratio of (the first absorbance peak at 1730 cm⁻¹)/(the second absorbance peak at 1080 cm⁻¹) ratio was used with Equation 3 to obtain a range where the swellable adhesive binder was detected from a surface portion of the heat resistant adhesive layer, and the results are shown in Table 2.

### Evaluation Example 3: Wet Adhesive Strength Evaluation of Separator-Negative Electrode (Peeling Test)

Each of the rechargeable lithium battery cells according to Examples and Comparative Examples is maintained at 40° C. under a load of 50 kg for 2 hours. Subsequently, after separating the separator from the negative electrode by about 15 mm away and fixing the separator into an upper grip, while fixing the negative electrode into a lower grip, the separator is elongated in a direction of 180° to peel it at 100 mm/min. Then, a force required for the peeling by 40 mm away is three times measured and then, averaged to obtain an arithmetic mean, and the results are shown in Table 2.

TABLE 2

| | Separator | | | | |
|---|---|---|---|---|---|
| | | | | | Separator- |
| | | | ATR-IR | Distribution | negative |
| | Dry shrinkage | | first | of | electrode |
| | rate of | | absorbance | swellable | wet |
| | separator | | peak/second | adhesive | adhesive |
| | MD | TD | absorbance | binder | force |
| | (%) | (%) | peak | (thickness %) | (gf/mm) |
| Example 1 | 2.5 | 2 | 0.088 | 9.5 | 0.16 |
| Example 2 | 2.5 | 2 | 0.075 | 9.4 | 0.12 |
| Example 3 | 2.5 | 2 | 0.063 | 9.3 | 0.11 |
| Example 4 | 2.5 | 2 | 0.079 | 8.6 | 0.14 |
| Example 5 | 2.5 | 2 | 0.060 | 7.3 | 0.10 |
| Example 6 | 2.5 | 2 | 0.095 | 10.6 | 0.17 |
| Example 7 | 2.5 | 2 | 0.099 | 11.9 | 0.17 |
| Comparative | 2.5 | 2 | 0.047 | 6.7 | 0.08 |
| Example 1 | | | | | |
| Comparative | 2.5 | 2 | 0.101 | 12.1 | 0.20 |
| Example 2 | | | | | |
| Comparative | 2.5 | 2 | 0.041 | 4.5 | 0.06 |
| Example 3 | | | | | |
| Comparative | 2.5 | 2 | 0.104 | 12.5 | 0.22 |
| Example 4 | | | | | |

### Evaluation Example 4: High-temperature Cycle-life and High-temperature Storage Characteristics of Rechargeable Lithium Battery Cell

### (1) High-Temperature Cycle-life Characteristics

Each of the rechargeable lithium battery cells of the examples and the comparative examples is charged at 4.25 V at a constant current of 0.1 C and discharged to a cut-off voltage of 3.5 V at a constant current of 0.1 C at 55° C. as initial charge and discharge. Subsequently, the cells are ten (10) times repeatedly charged/discharged within a voltage range of 3.5 V to 4.25 V at 0.5 C.

After the 10 cycles, a temperature of the rechargeable lithium battery cells is measured to calculate a temperature increase from the initial temperature, and the results are shown in Table 3.

In addition, the 10-cycle efficiency of the rechargeable lithium battery cells is calculated according to Equation 4, and the results are shown in Table 4.

$$10 - cycle efficiency of rechargable lithium battery cell = ( discharge capacity after 10 th cycle / discharge capacity after 1 st cycle ) ⋆ 100 \qquad Equation 4$$

### (2) High-temperature Storage Characteristics

Each of rechargeable lithium battery cells of Examples and Comparative Examples that underwent initial charging and discharging was stored at 60° C., the period (storage days) from 100% to 80% of SOH (state of health) and high-temperature storage efficiency according to Equation 5 were confirmed, and are shown in Table 3.

$$High - temperature storage efficiency of rechargable lithium battery cell = ( discharge capacity after SOH 80 \% / initial discharge capacity ) ⋆ 100 \qquad Equation 5$$

TABLE 4

| Rechargeable lithium battery cell | |
|---|---|
| High-temperature | High-temperature |
| cycle-life | storage |
| (55° C., 10 cyc.) | (60° C., SOH 80%) |

| | temperature | storage | storage |
|---|---|---|---|
| | change | efficiency | days |
| | (° C.) | (%) | (days) |
| Example 1 | 2.6 | 99 | 360 |
| Example 2 | 3.3 | 97 | 360 |
| Example 3 | 3.5 | 97 | 330 |
| Example 4 | 2.8 | 98 | 360 |
| Example 5 | 3.5 | 95 | 300 |
| Example 6 | 2.6 | 94 | 300 |
| Example 7 | 3.8 | 94 | 300 |
| Comparative | 7.1 | 95 | 210 |
| Example 1 | | | |
| Comparative | 9.6 | 89 | 120 |
| Example 2 | | | |
| Comparative | 8.1 | 93 | 240 |
| Example 3 | | | |
| Comparative | 10.2 | 88 | 90 |
| Example 4 | | | |

### SUMMARY

The separator of some example embodiments, which was represented by Examples 1 to 7, exhibited desired or improved heat resistance and also, had an enhanced adhesive force in coating layer surface portion of at least one surface, resultantly improving high temperature charging and discharging and/or storage characteristics of rechargeable lithium batteries.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

### DESCRIPTION OF SYMBOLS

| | |
|---|---|
| 100: rechargeable lithium battery | 10: separator |
| 40: positive electrode | 50: negative electrode |
| 60: electrode assembly | 70: battery case |

What is claimed is:

1. A separator for a rechargeable lithium battery, the separator comprising:
a substrate;
a heat resistant adhesive layer on one surface of the substrate,
wherein the heat resistant adhesive layer includes:
inorganic particles,
a heat resistant binder, and
a swellable adhesive binder,
the swellable adhesive binder includes:
a first structural unit derived from a vinyl aromatic monomer;
a second structural unit derived from an alkyl acrylate; and
a third structural unit derived from a phosphonate-based monomer, and
when measuring the separator with an FT-IR (Fourier Transform Infrared Spectrometer) in ATR (Attenuated Total Internal Reflectance) mode, the swellable adhesive binder is distributed in about 7% to about 12% of the thickness from a surface portion of the heat resistant adhesive layer is detected.

2. The separator as claimed in claim 1, wherein when measuring the separator with an FT-IR (Fourier Transform Infrared Spectrometer) in ATR (Attenuated Total Internal Reflectance) mode, a ratio of a first absorbance peak at 1730 cm⁻¹ over a second absorbance peak at 1080 cm⁻¹ is in a range of about 0.05 to about 0.1.

3. The separator as claimed in claim 1, wherein the heat resistant adhesive layer satisfies both Equations 1 and 2:
$$1 / 20 < ( A + B ) / C < 1 / 5 \qquad Equation 1$$
$$1 / 30 < A / B < 1 / 2 \qquad Equation 2$$
wherein, in Equations 1 and 2,
A is a weight of the heat resistant binder,
B is a weight of the swellable adhesive binder, and
C is a weight of the inorganic particles.

4. The separator as claimed in claim 3, wherein Equation 1 satisfies Equation 1-1:
$$1 / 12 \leq ( A + B ) / C \leq 1 / 7. \qquad Equation 1 - 1$$

5. The separator as claimed in claim 3, wherein
Equation 2 satisfies Equation 2-1:
$$1 / 19 \leq A / B \leq 1 / 13. \qquad Equation 2 - 1$$

6. The separator as claimed in claim 1, wherein in the swellable adhesive binder,
the first structural unit derived from the vinyl aromatic monomer is represented by Chemical Formula 1,
the second structural unit derived from the alkyl acrylate is represented by Chemical Formula 2, and
the third structural unit derived from the phosphonate-based monomer is represented by Chemical Formula 3: 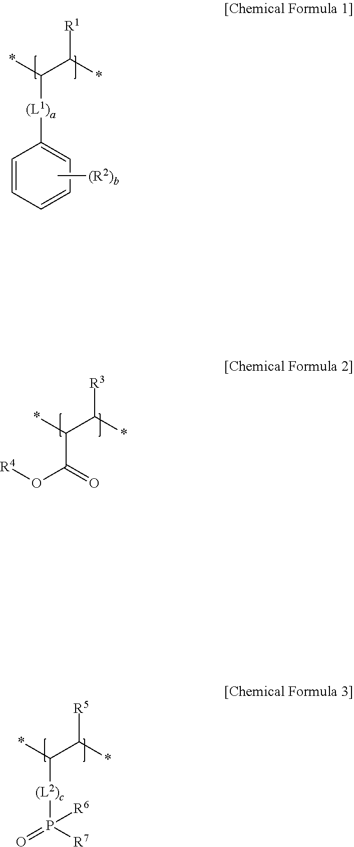
wherein, in Chemical Formulas 1 to 3,
R¹, R³, and R⁵ each independently comprise hydrogen or a C1 to C6 alkyl group;
R² comprises at least one of fluorine, a substituted or unsubstituted C1 to C6 alkyl group, a substituted or unsubstituted C6 to C20 aryl group, or a substituted or unsubstituted C1 to C6 alkenyl group,
R⁴ comprises a substituted or unsubstituted C1 to C20 alkyl group,
R⁶ comprises at least one of a hydroxy group (—OH), a substituted or unsubstituted C1 to C6 alkoxy group, or a substituted or unsubstituted C6 to C20 aryloxy group,
R⁷ comprises a hydroxy group (—OH), or a substituted or unsubstituted C1 to C6 alkoxy group,
L¹ comprises at least one of a substituted or unsubstituted C1 to C6 alkylene group, a substituted or unsubstituted C3 to C10 cycloalkylene group, and a substituted or unsubstituted C6 to C20 arylene group,
L² comprises at least one of a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, and a substituted or unsubstituted C6 to C20 arylene group,
“a” and “c” are each independently integers in a range of 0 to 2, and
“b” is an integer in a range of 0 to 5.

7. The separator as claimed in claim 6, wherein:
the swellable adhesive binder comprises a particle with a core-shell structure, and
the shell comprises the first structural unit derived from a vinyl aromatic monomer, the second structural unit derived from an alkyl acrylate, and the third structural unit derived from a phosphonate-based monomer.

8. The separator as claimed in claim 1, wherein:
the heat resistant binder comprises at least one of a first heat resistant binder, and a second heat resistant binder,
wherein the first heat resistant binder comprises:
a fourth structural unit derived from (meth)acrylic acid or (meth)acrylate;
a fifth cyano group-containing structural unit; and
a sixth sulfonate group-containing structural unit, and
the second heat resistant binder comprises:
a seventh structural unit including at least one of a structural unit derived from (meth)acrylic acid or (meth)acrylate and a structural unit derived from (meth)acrylamide; and
an eighth structural unit derived from (meth)acrylamidosulfonic acid or a salt thereof.

9. The separator as claimed in claim 8, wherein:
the fourth structural unit derived from (meth)acrylic acid or (meth)acrylate is represented by any one of Chemical Formula 11, Chemical Formula 12, Chemical Formula 13, and a combination thereof,
the fifth cyano group-containing structural unit is represented by Chemical Formula 14, and
the sixth sulfonate group-containing structural unit is represented by any one of Chemical Formula 15, Chemical Formula 16, Chemical Formula 17, and a combination thereof: 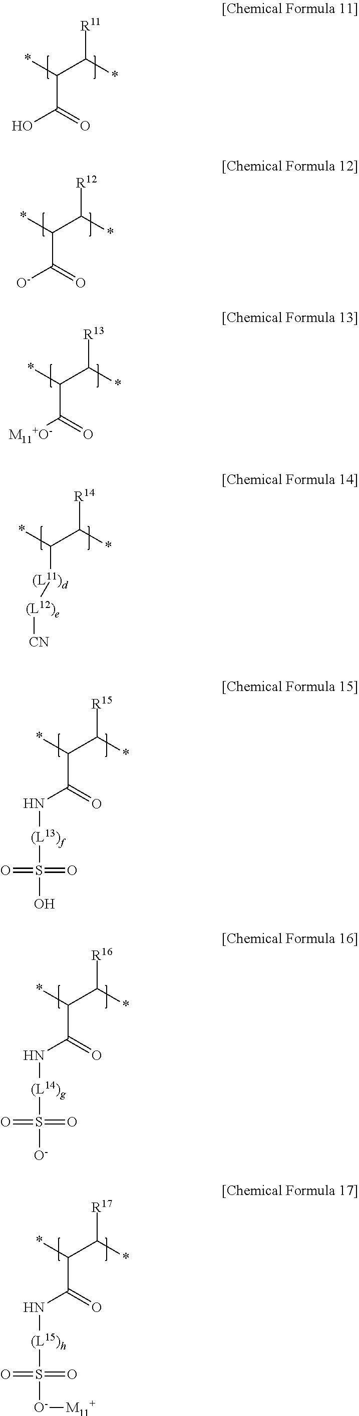
wherein, in Chemical Formulas 11 to 17,
R¹¹ to R¹⁷ each independently comprise hydrogen or a C1 to C6 alkyl group;
L¹¹ and L¹² each independently comprise at least one of a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
L¹³ to L¹⁵ each independently comprise at least one of a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₁ comprises an alkali metal; and
d, e, f, g, and h are each independently integers in a range of 0 to 2.

10. The separator as claimed in claim 8, wherein:
the fourth structural unit derived from (meth)acrylic acid or (meth)acrylate is represented by any one of Chemical Formula 101, Chemical Formula 102, Chemical Formula 103, and a combination thereof,
the structural unit derived from the (meth)acrylamide is represented by Chemical Formula 104, and
the eighth structural unit derived from the (meth)acrylamidosulfonic acid or the salt thereof is represented by any one of Chemical Formula 105, Chemical Formula 106, Chemical Formula 107, and a combination thereof: 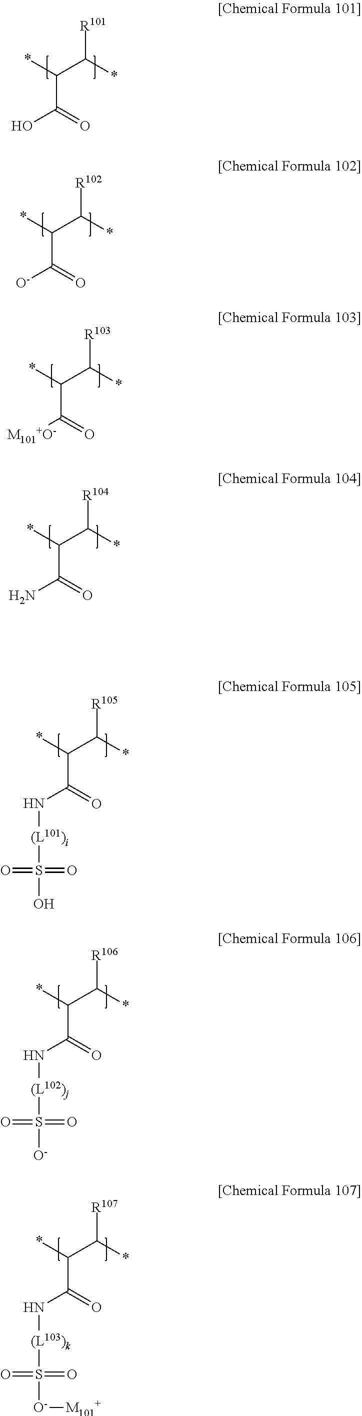
wherein, in Chemical Formulas 101 to 107,
R¹⁰¹ to R¹⁰⁷ each independently comprise hydrogen or a C1 to C6 alkyl group;
L¹⁰¹ to L¹⁰³ each independently comprise at least one of a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₀₁ comprises an alkali metal; and
i, j, and k are each independently integers in a range of 0 to 2.

11. The separator as claimed in claim 1, wherein the inorganic particles comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

12. The separator as claimed in claim 1, wherein a D50 particle size of the inorganic particle is in a range of about 0.1 μm to about 10 μm.

13. The separator as claimed in claim 1, wherein a thickness of the heat resistant adhesive layer is in a range of about 0.1 μm to about 5 μm.

14. The separator as claimed in claim 1, wherein the separator comprises:
a heat resistant layer on another surface of the substrate from the heat resistant adhesive layer,
the heat resistant layer comprises:
inorganic particles; and
a heat resistant binder.

15. The separator as claimed in claim 1, wherein a thickness of the heat resistant adhesive layer is in a range of about 0.1 μm to about 4 μm.

16. The separator as claimed in claim 1, wherein the substrate comprises a polyolefin-based substrate.

17. The separator as claimed in claim 1, wherein a thickness of the substrate is in a range of about 1 μm to about 40 μm.

18. A rechargeable lithium battery, comprising:
a positive electrode;
a negative electrode; and
the separator as claimed in claim 1 between the positive electrode and the negative electrode.

19. The rechargeable lithium battery as claimed in claim 18, wherein the heat resistant adhesive layer is attached to the negative electrode.
